(19) United States
(12) Patent Application Publication
(10) Pub. No.: US 2025/0004928 A1
(43) Pub. Date: Jan. 2, 2025

(54) AUTOMATED SOFTWARE TESTING USING NATURAL LANGUAGE-BASED SCRIPT EXECUTION

(71) Applicant: Microsoft Technology Licensing, LLC, Redmond, WA (US)

(72) Inventors: William Tigard BAKER, Redmond, WA (US); Swamy V. P. L. N. NALLAMALLI, Bothell, WA (US); Dallas Allen WARREN, Redmond, WA (US); Piyush GUPTA, Sammamish, WA (US); Aaron Edward DIETRICH, Kirkland, WA (US)

(21) Appl. No.: 18/214,616

(22) Filed: Jun. 27, 2023

(51) Int. Cl. G06F 11/36

(52) U.S. Cl. CPC G06F 11/3688; G06F 11/3664; G06F 11/368

(57) ABSTRACT

Aspects of the disclosure include methods and systems for performing automated software testing. The method includes obtaining a test script for software, executing the test script, and determining that the test script includes an action that cannot be completed. The method also includes identifying elements of a user interface of the software, inputting, into a natural language processing system, a query including the action and the elements, and receiving, in response to the query, an identified element. The method further includes continuing the executing of the software by performing the action on the identified element and determining that an updated user interface includes an element associated with the action of the test script. The method also includes updating the test script by adding a new action to the test script based on a determination that the updated user interface includes the element associated with the action.

The subject disclosure relates to software testing, and particularly to automated software testing using natural language-based script execution.

Testing software prior to its release is often performed to ensure the quality and reliability of the software. Proper testing helps identify bugs, errors, and usability issues, allowing developers to fix them before the software reaches users. Traditionally, testing of new software was a manual task that that required software developers to spend significant resources to ensure proper operation of the software. Attempts to reduce the time and resources required for testing new software products led to the use of test scripts to test software. Test scripts are written in a programming or scripting language and are used to automate the execution of test cases.

Automated testing with test scripts can significantly improve the efficiency of the software testing process. Scripts can execute tests much faster than manual testing, allowing for quicker feedback on the software's quality and reducing the time required for testing. In addition, test scripts ensure that the same set of tests are executed consistently, eliminating human errors and variations in test execution.

While test scripts can greatly enhance the efficiency and effectiveness of software testing, test scripts require substantial effort to develop and maintain and certain aspects of testing still require manual intervention. For example, minor changes in the naming and/or placement of user interface elements for a new version of a software product will often cause the execution of a testing script written for the prior version of the software to fail. As a result, in order to function properly the testing scripts must be updated each time the software product is updated.

### SUMMARY

Embodiments of the present disclosure are directed to methods for automated testing of software. An example method includes obtaining a test script for testing the software, executing the software based on the test script, and determining that the test script includes an action that cannot be completed. The method also includes identifying one or more elements of a user interface of the software, inputting, into a natural language processing system, a query comprising the action and the one or more elements, and receiving, from the natural language processing system in response to the query, an identified element of the one or more elements. The method further includes continuing the executing of the software by performing the action on the identified element on the user interface, determining that an updated user interface includes a user interface element associated with the action of the test script, and updating the test script.

Embodiments of the present disclosure are directed to methods for automated testing of software. An example method includes obtaining a test script for testing the software, executing the software based on the test script, and determining that the test script includes an action that cannot be completed. The method also includes identifying one or more elements of a user interface of the software, inputting, into a natural language processing system, a query comprising the action and the one or more elements, and receiving, from the natural language processing system in response to the query, an identified element of the one or more elements. The method further includes continuing the executing of the software by performing the action on the identified element on the user interface, determining that performing the action on the identified element resulted in completion of the action, and updating the test script.

Embodiments of the present disclosure are directed to a system having a memory, computer readable instructions, and processing system for executing the computer readable instructions. The computer readable instructions controlling the processing system to perform operations including executing software based on a test script, determining that the test script includes an action that cannot be completed, and identifying one or more elements of a user interface of the software. The operations also include inputting, into a natural language processing system, a first query comprising the action and the one or more elements, receiving, from the natural language processing system in response to the first query, a first identified element of the one or more elements, and continuing the executing of the software by performing the action on the first identified element on the user interface. The operations further include determining that performing the action on the first identified element resulted in completion of the action and updating the test script.

The above features and advantages, and other features and advantages of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1 depicts a block diagram of an example system for automated testing of software under test in accordance with one or more embodiments;

FIG. 2 depicts an example testing script for automated testing of the software under test in accordance with one or more embodiments:

FIGS. 3A and 3B depict examples of user interfaces of a first version of the software under test in accordance with one or more embodiments:

FIGS. 4A, 4B, and 4C depict examples of user interfaces of a second version of the software under test in accordance with one or more embodiments:

FIG. 5 depicts an example of a query and response of a natural language processing system in accordance with one or more embodiments:

FIG. 6 depicts an example updated testing script for automated testing of the software under test in accordance with one or more embodiments:

FIG. 7 depicts an example flowchart of a method for automated software testing in accordance with one or more embodiments:

FIG. 8 depicts an example testing script for automated testing of the software under test in accordance with one or more embodiments:

FIG. 9 depicts an example of a user interface of a first version of the software under test in accordance with one or more embodiments:

FIG. 10 depicts an example of a user interface of a second version of the software under test in accordance with one or more embodiments:

FIG. 11 depicts an example of a query and response of a natural language processing system in accordance with one or more embodiments:

FIG. 12 depicts an example updated testing script for automated testing of the software under test in accordance with one or more embodiments:

FIG. 13 depicts an example flowchart of a method for automated software testing in accordance with one or more embodiments:

FIG. 14 depicts an example flowchart of a method for automated software testing in accordance with one or more embodiments:

FIG. 15 depicts an example flowchart of a method for automated software testing in accordance with one or more embodiments; and

FIG. 16 depicts an example block diagram of a computer system according to one or more embodiments.

The diagrams depicted herein are illustrative. There can be many variations to the diagrams or the operations described therein without departing from the spirit of the disclosure. For instance, the actions can be performed in a differing order or actions can be added, deleted, or modified.

In the accompanying figures and following detailed description of the described embodiments of the disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

As discussed above, while test scripts can improve the efficiency and effectiveness of software testing, certain aspects of software testing still require manual intervention. One common area of software testing that requires manual intervention is updating testing scripts each time changes are made to software product.

This disclosure involves the use of natural language processing systems, such as large language models, to automatically attempt to overcome obstacles encountered when executing a test script on the software under test. Aspects of the present disclosure include identifying an action in the test script that cannot be completed. For example, the test script may include an action to select a specific user interface element, which is not present on the user interface. As used herein, a user interface element is an element of a user interface that can be interacted with, such as a textual input field, a button, or the like. Aspects of the present disclosure also include identifying available user interface elements of the software under test and providing the available user interface elements and the action to a natural language processing system as a query. The query requests that the natural language processing system identify one of the available user interface elements that is most closely related to the action. In various embodiments, depending on the type of natural language processing system used, the labels of the textual input fields may be provided to the natural language processing system as one of a query, a prompt, or in another structured format. The term query used herein is intended to generally refer to any structured input that is provided to the natural language processing system to obtain the input text from the natural language processing system.

Once a response, including the identified element, is received from the natural language processing system, aspects of the disclosure include performing the action on the identified element and identifying whether performing the action on the identified element results in the completion of the action. Based on a determination that performing the action on the identified element resulted in the completion of the action, an updated version of the test script is created and saved.

Advantageously, automated software testing methods and systems are provided that utilize a natural language processing system to overcome obstacles encountered during execution of a test script. By leveraging the natural language processing system to overcome encountered obstacles the efficiency of software testing methods and systems is increased by reducing the number of errors generated by the testing system. Automatically overcoming encountered obstacles using the leveraging the natural language processing system improves the computational efficiency of the software testing system by reducing errors that may be generated by the software testing system and by preventing the software testing system from becoming unresponsive when encountering an action that it cannot execute.

Moreover, providing automated software testing tools that leverage natural language processing systems for script execution reduces the amount of time required for testing software products by eliminating the need for users to manually generate updated testing scripts for new versions of the software under test. In addition, automated software testing that uses natural language processing systems for executing a test script allows testing to be performed more rapidly than traditional testing software by reducing the amount input needed from a user during testing to resolve execution errors.

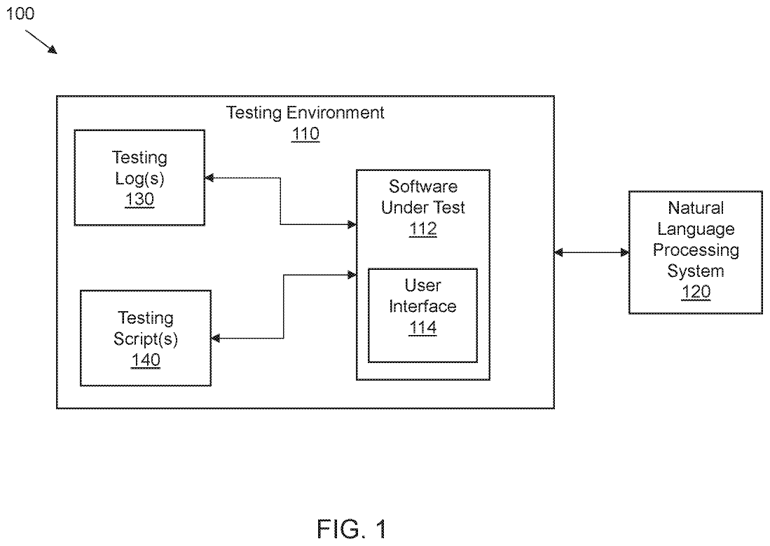

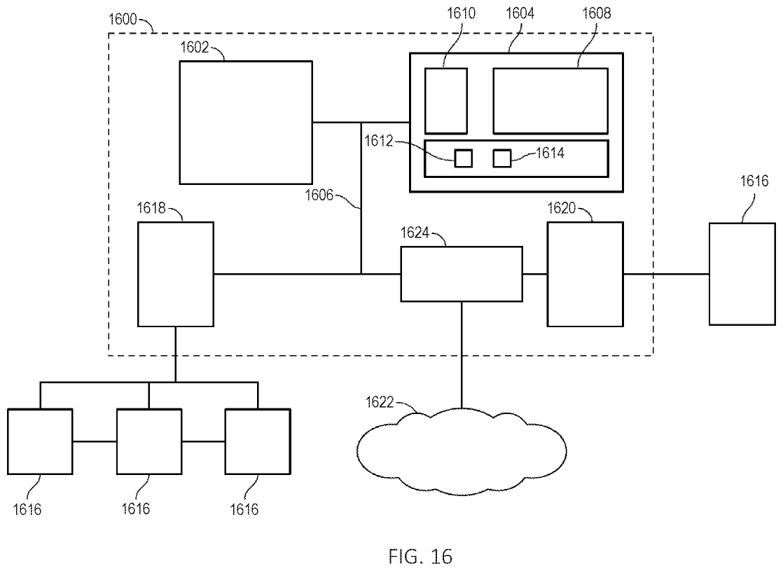

Referring now to FIG. 1, a block diagram of a system 100 for automated testing of the software under test in accordance with one or more embodiments is shown. As illustrated, the system 100 includes a testing environment 110 having the software under test 112, a testing log 130, and a test script 140. The system 100 also includes a natural language processing system 120. Although illustrated as discrete items, the testing environment 110 and the natural language processing system 120 may be embodied in a single computing system, such as the one shown in FIG. 16. Alternatively, each of the testing environment 110 and the natural language processing system 120 may be embodied in separate computing systems, such as the one shown in FIG. 16.

In one embodiment, the testing environment 110 is a computing system that includes a configuration of hardware, software, and network resources required to perform software testing activities of the software under test 112, which includes a user interface 114. The testing environment 110 includes monitoring and logging mechanisms that capture relevant metrics, errors, and performance data during testing and store these metrics in the testing log 130. The testing log 130 is used to analyze the behavior of the software under test 112, diagnose issues of the software under test 112, and gather insights for further improvements to the software under test 112. In one embodiment, the testing script 140 is a script that is used by the testing environment 110 to perform automated testing on the software under test. In general, the testing script 140 includes a series of actions that are sequentially performed on the software under test 112 via the user interface of the software under test 112.

In one embodiment, the natural language processing system 120 is a computing system that receives an input that identifies the action from a testing script and one or more user interface elements from the testing environment 110 and generates responses in a way that is similar to how humans communicate. In general, natural language processing systems are computer-based technologies that aim to enable computers to understand, interpret, and generate human language. These systems utilize various computational techniques and algorithms to process and analyze textual data in order to extract meaning, understand context, and perform tasks related to language understanding and generation. Natural language processing systems encompass a wide range of subfields and techniques, including information retrieval, text classification, sentiment analysis, machine translation, question answering, chatbots, and more. These systems often employ statistical models, machine learning algorithms, and linguistic rules to process and analyze text, enabling them to perform tasks like information extraction, sentiment analysis, document classification, and language translation.

The natural language processing system 120 may employ a combination of techniques from various fields, including linguistics, computer science, artificial intelligence, and machine learning. The natural language processing system 120 can include an information retrieval system, a question answering system, a chatbot system, and a text generation system. Such natural language processing systems can include PyTorch-NLP, OpenNLP, and StanfordNLP.

In one embodiment, the natural language processing system 120 is a machine learning model that has been trained to select an element from a set of elements that most closely relates to a specified action. The machine learning model is created by first obtaining training data, which may be structured or unstructured data. According to one or more embodiments described herein, the training data includes user interface elements that correspond to actions of test scripts. Once the training data is obtained, a training module receives the training data and an untrained model. The untrained model can have preset weights and biases, which can be adjusted during training. It should be appreciated that the untrained model can be selected from many different model forms depending on the task to be performed. For example, where the training is to train a model to perform image classification, the untrained model may be a model form of a CNN. The training can be supervised learning, semi-supervised learning, unsupervised learning, reinforcement learning, and/or the like, including combinations and/or multiples thereof. The training may be performed multiple times (referred to as “epochs”) until a suitable model is trained. Once trained, the trained model is configured to select an element from a set of elements that most closely relates to a specified action by applying the trained model to new data. (e.g., real-world, non-training data).

In one embodiment, the natural language processing system 120 includes a large language model, which is an artificial intelligence model that has been trained on vast amounts of textual data to understand and generate human-like language. Such large language models can include GPT-2, GPT-3, GPT-4 by OpenAI, Guanaco, OpenLLaMa, and StableLM. In this embodiment, the large language model is provided with an input that includes a request to select a user interface element from a group of user interface elements that is most closely related to an action in a testing script. In response to the input, the large language model generates a response that includes an identified element that most closely related to an action in a testing script.

In one embodiment, the natural language processing system 120 includes an information retrieval system that retrieves relevant information from large collections of unstructured text. The information retrieval system typically uses techniques like indexing, querying, and ranking to match user queries with the most relevant documents. In this embodiment, the information retrieval system is provided with an action of testing script and a group of user interface elements. In response to the input, the information retrieval system selects a user interface element by querying the collection of unstructured text, determining a relationship between each of the provided user interface elements and the action, and ranking the relationship between each of the provided user interface elements and the action. The natural language processing system 120 selects the user interface element from the provided group of user interface elements that has the highest ranked relationship with the provided action and outputs the selected the identified element.

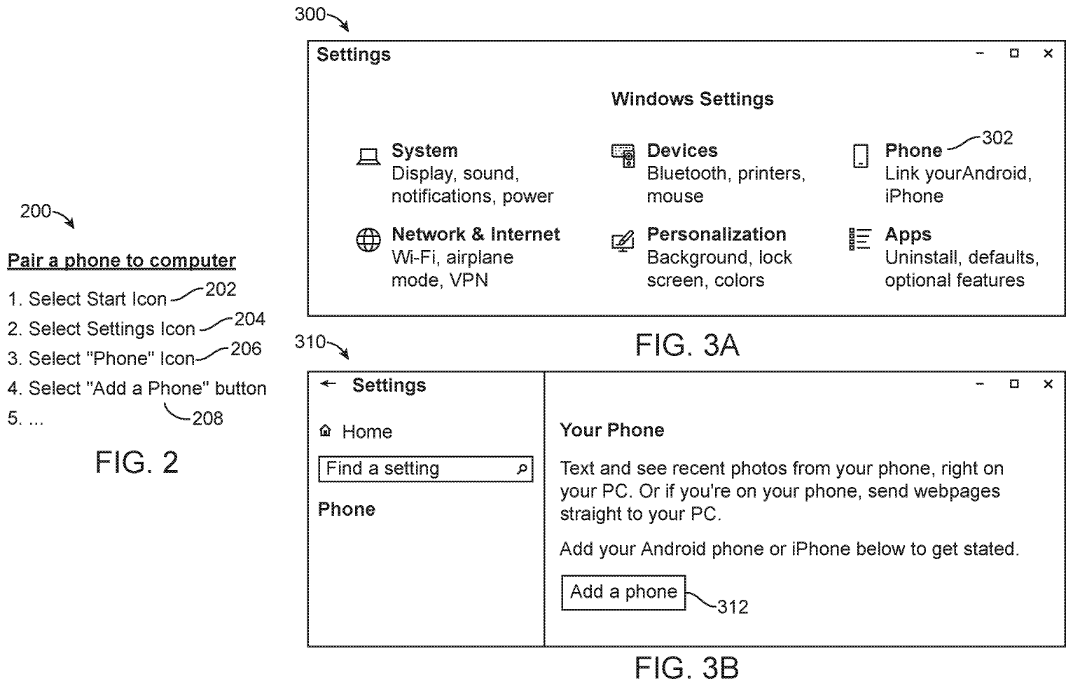

Referring now to FIG. 2, a testing script 200 for automated testing of the software under test in accordance with one or more embodiments is shown. As illustrated, the testing script 200 is a script for pairing a new phone to a computer. The testing script 200 includes a series of actions that include a first action 202 “Select a Start Icon”, a second action 204 “Select Settings Icon”, a third action 206 “Select Phone Icon”, and a fourth action 208 “Select ‘Add a Phone’ button.” In one embodiment, the script 200 may also include other metadata that assists with the execution of the steps of the script. For example, the other metadata can include an expected location of a user interface element that corresponds to the step of the script.

Referring now to FIGS. 3A and 3B, examples of user interfaces 300 and 310 of a first version of the software under test in accordance with one or more embodiments are respectively shown. The testing script 200 shown in FIG. 2, is a testing script that was created for the first version of the software under test that is depicted in FIGS. 3A and 3B. In one embodiment, after the first action 202 and the second action 204 are successfully completed by the software under test, user interface 300 is displayed. The third action 206 of the test script 200 is then executed by selecting the phone icon 302 from the user interface 300. Next, the user interface 310 is displayed and the fourth action 208 of the test script 200 is executed by selecting the phone icon 302 from the user interface 300.

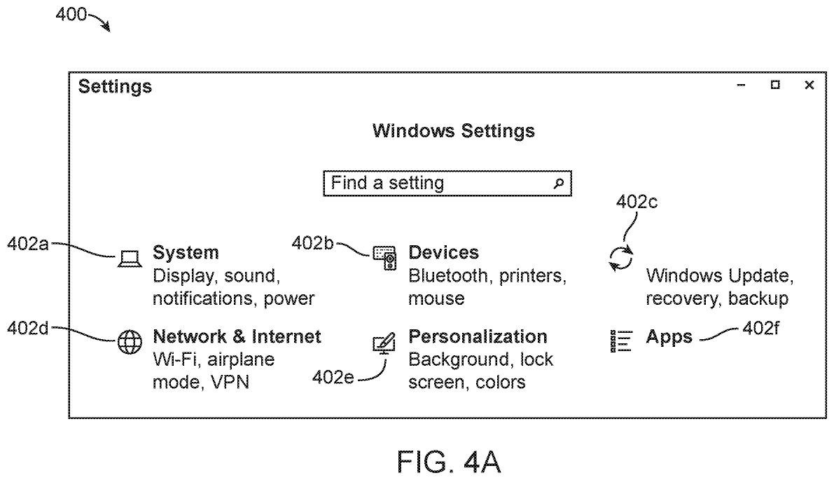

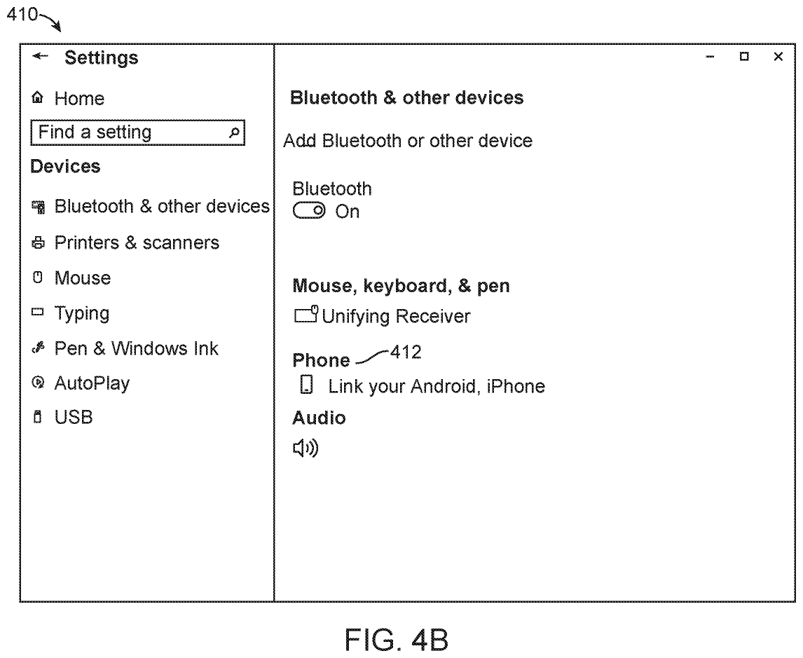

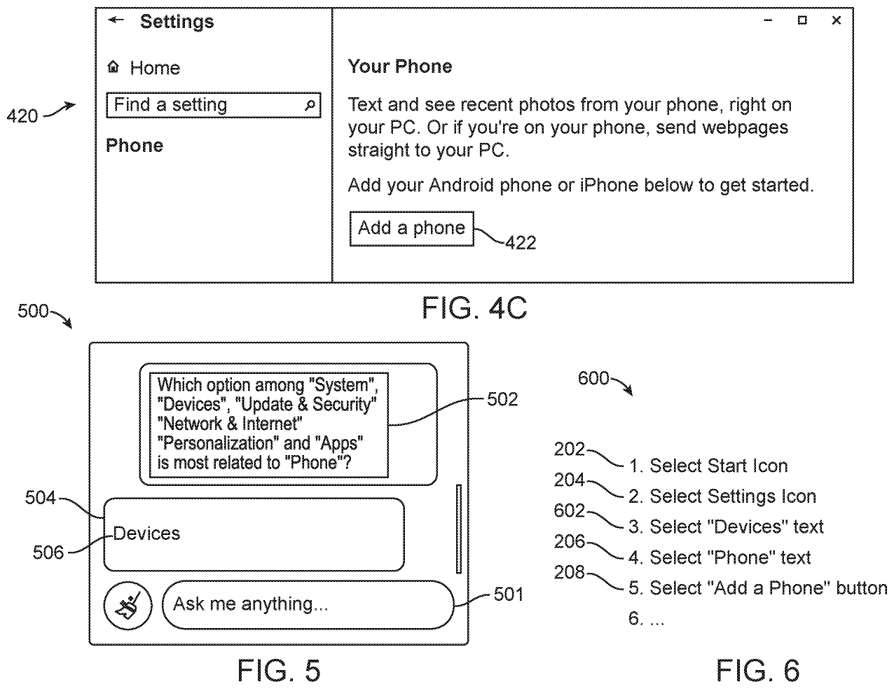

Referring now to FIG. 4A an example of user interfaces 400 of a second version of the software under test in accordance with one or more embodiments is shown. As illustrated, user interface 400 has been modified when compared to user interface 300, shown in FIG. 3A, to remove the phone icon 302. As a result, when testing the software under test with the test script 200, the testing environment will not be able to perform the third action 206 “Select Phone Icon.” In one embodiment, the determination that the testing script 200 includes an action that cannot be completed includes determining that the action requires performing an action on a user interface element that is not present on the user interface. For example, the determination can be made based on searching the user interface for a user interface element specified by the action of the testing script 200 and determining that the user interface element specified by the action is not present. In one example, the testing environment identifies all of the elements of the user interface and compares the elements to the user interface element specified by the action. Once a determination the testing script 200 includes an action that cannot be completed, execution of the testing script 200 is paused and the testing environment interacts with a natural language processing system as described below.

In one embodiment, based on a determination that the testing script 200 includes an action that cannot be completed, one or more elements 402a, 402b, 402c, 402d, 402e, and 402f of the user interface 400 of the software under test are identified. In one embodiment, the labels of the elements are identified by the testing environment and are provided to the natural language processing system along with the action and the natural language processing system returns an identified element. In one embodiment, identifying each of the one or more elements 402a, 402b, 402c, 402d, 402e, and 402f of the user interface 400 also includes identifying a label associated with each of the elements 402. For example, element 402a has a label of “System” and element 402b has a label of “Devices.” In one embodiment, the label of an element is identified based at least in part on its location relative to the element. For example, the label can be identified as the text located closest to the element. In another example, determining the label of an element can include obtaining the relationship between the element and labels from an accessibility markup of the software under test or based on identifying a similarity between the names of the element and labels (e.g., “Label_1”, “Input_1”).

Referring now to FIG. 5, an example of a query and response of a natural language processing system 500 in accordance with one or more embodiments is shown. In one embodiment, the natural language processing system 500 includes an input field 501 that is used to submit a query 502. In another embodiment, the query 502 is input into the natural language processing system 500 via an application programming interface (API) of the natural language processing system.

As illustrated, a query 502 is provided to the natural language processing system 500 that requests the natural language processing system 500 to identify one of the one or more elements 402a, 402b, 402c, 402d, 402e, and 402f that is most closely related to the action 206. In response to the query 502, the natural language processing system 500 provides a response 504 that includes an identified element 506. In the illustrated example, the identified element 506 is the devices element 402b.

Continuing with reference to FIG. 4A, based on receiving the identified element of the devices element 402b from the natural language processing system, the testing of the software under test continues by selecting the devices element 402b of the user interface 400. Once the devices element 402b of the user interface 400 is selected, the user interface of the software under test is updated to the user interface 410 that is shown in FIG. 4B.

In one embodiment, the elements of the user interface 410 are then identified and compared to the third action 206 of the script. For example, the third action 206, “Select ‘Phone’ Icon” is compared with the elements of user interface 410 (e.g., the items shown on user interface 410 that can be interacted with), such as “Mouse, keyboard, & pen,” “Phone,” “Audio”, “Home,” and the like. Based on a determination that the user interface 410 includes an element associated with the third action 206 the execution of the test script continues by selecting the element associated with the third action 206. In the illustrated example, the user interface 410 does include an element, phone icon 412, that is associated with the third action 206. Accordingly, execution of the test script 200 is continued by selecting the phone icon 412. Once the phone icon 412 of the user interface 410 is selected, the user interface of the software under test is updated to the user interface 420 that is shown in FIG. 4C and the script continues by performing the fourth action 208 and clicking on the Add a phone button 422.

In another embodiment, the elements of the user interface 410 are identified and compared to the fourth action 208 of the script. Based on a determination that the user interface 410 includes an element associated with the fourth action 208, the execution of the test script continues by selecting the element associated with the fourth action 208. In this embodiment, it is determined that the selection of identified element 412 resulted in the completion of the third action 206.

In one embodiment, the testing environment is configured to automatically update the testing script by creating and saving a new version of the testing script, each time an action is successfully performed using input received from the natural language processing system.

Referring now to FIG. 6 an updated testing script 600 for automated testing of the software under test in accordance with one or more embodiments is shown. The updated testing script 600 is an updated version of the testing script 200, shown in FIG. 2, that is created by the testing environment based on the detected changes to the user interface of the software under test and the input received from the natural language processing system. As illustrated, the updated testing script 600 includes a new action 602 “Select ‘Devices’ Icon that has been inserted between the second action 204 and the third action 206.

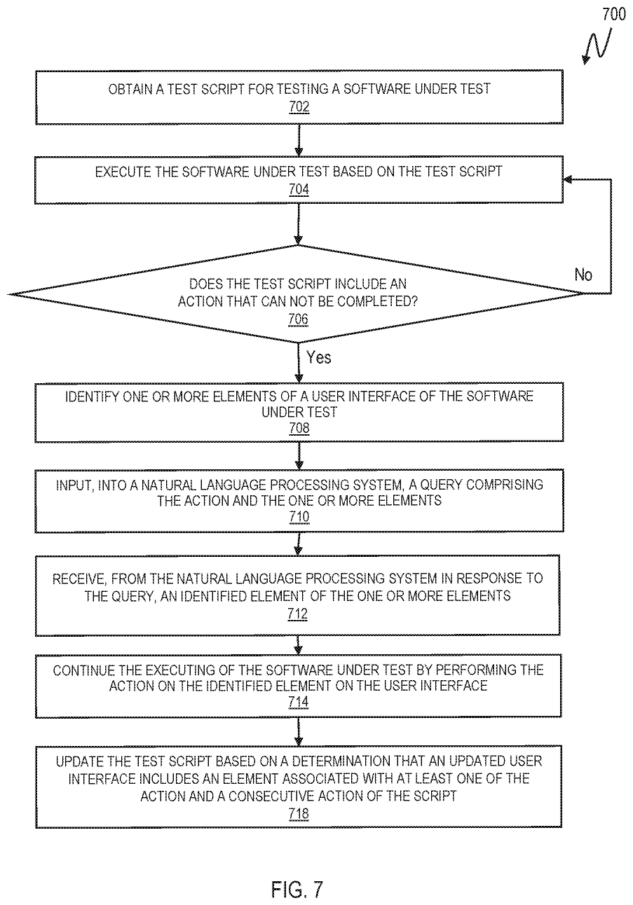

Referring now to FIG. 7, a flowchart of a method 700 for automated software testing in accordance with one or more embodiments is shown. The method 700 is described with reference to FIGS. 1 to 6 and may include additional steps not depicted in FIG. 7. Although depicted in a particular order, the blocks depicted in FIG. 7 can be, in some embodiments, rearranged, subdivided, and/or combined.

At block 702, the method 700 begins by obtaining a testing script for the software under test. In one embodiment, the test script is obtained from a user. In another embodiment, the test script is obtained from a machine learning model. The machine learning model is created by first obtaining training data, which may be structured or unstructured data. According to one or more embodiments described herein, the training data includes observational data of interactions of users with a prior version of the software under test and an identification of a function of the software under test that correspond to the user interactions. The observational data of interactions of users with a prior version of the software under test correspond to a specific function of the software, such as pairing a new phone to a computer or adding a record to a database. For example, observational data on user interactions with the prior version of the software is collected via user logs and telemetry. Next, the observational data can be preprocessed to remove any irrelevant or noisy entries, handle missing values or outliers as necessary, and ensure that the data is in a suitable format for training the machine learning model. Once the training data is obtained and preprocessed, a training module receives the training data and an untrained model. The untrained model can have preset weights and biases, which can be adjusted during training. It should be appreciated that the untrained model can be selected from many different model forms depending on the task to be performed. The training can be supervised learning, semi-supervised learning, unsupervised learning, reinforcement learning, and/or the like, including combinations and/or multiples thereof. The training may be performed multiple times (referred to as “epochs”) until a suitable model is trained. Once trained, the trained model is configured to generate a test script for a new version the software under test based on input of a function of the software. The machine learning model will learn from the observed user interactions and generate test scripts that resemble real user behavior.

At block 704, the method 700 includes executing the software under test. The software under test can include an operating system, application software, web-based software, and the like. In general, the software under test may be any type of software or application that has a user interface.

At decision block 706, the method 700 includes determining whether the testing script includes an action that cannot be completed. In one embodiment, determining that the test script includes an action that cannot be completed includes determining that the action refers to a first user interface element that is not among the elements of the user interface of the software. For example, the test script may include an action to select a specific user interface element, which is not present on the user interface. Based on a determination that the user interface of the software under test does not include an action that cannot be completed, the method 700 returns to block 704.

Based on a determination that the testing script includes an action that cannot be completed, the method 700 proceeds to block 708 and identifies one or more elements of a user interface of the software under test. In one embodiment, the one or more elements of a user interface of the software under test represent the available options that are presented to a user via the user interface for possible execution. In one embodiment, identifying the user interface elements includes identifying a label associated with each of the user interface elements. In some embodiments, the user interface elements of the software under test that are identified may be restricted to those user interface elements that appear in a specified portion of the user interface for the software under test. For example, for a testing script that is testing a settings menu on the software under test, only user interface elements that are a part of the “Settings” menu will be identified.

At block 710, the method 700 includes inputting into a natural language processing system the identified one or more elements of a user interface and the action as a query. In one embodiment, the query includes the label for each of identified one or more elements of the user interface. In one embodiment, the query is structured to request that the natural language processing system identify one of the one or more elements that is the most closely related to the action that cannot be completed. In one embodiment, the query is input into the natural language processing system via an application programming interface (API) of the natural language processing system. In one embodiment, the query is structured to ask the natural language processing system which of the available user interface elements most closely relate to the action of the testing script.

At block 712, the method 700 includes receiving, from the natural language processing system in response to the query, an identified element of the one or more elements. In one embodiment, the response from the query is received via the API of the natural language processing system.

At block 714, the method 700 includes continuing the executing of the software under test by performing the action on the identified element on the user interface. Once the identified element on the user interface has the action performed against it, an updated user interface may be displayed by the software under test. In various embodiments, performing the action on the identified element may include performing a mouse click on the identified element or performing another action against or on the user interface element. For example, the selection action may include performing a “swipe right” on the interface element or expanding a tree control.

The method 700 concludes at block 716 by updating the test script based on a determination that an updated user interface includes a user interface element that is associated with the action or a consecutive action of the script. As used herein, a consecutive action of a script is the next action of the test script. For example, in the test script 600 shown in FIG. 6, action 204 is the consecutive action to action 202. In one embodiment, the method 700 also includes transmitting an error notification to a user based on a determination that the updated user interface does not include an element associated with the action or the consecutive action of the script.

In one embodiment, updating the script includes updating the action to include the identified element based on a determination that the updated user interface includes an element associated with the consecutive action of the script. When the updated user interface includes an element associated with the consecutive action of the script, the action was successfully completed, and the text of the action is updated to include the identified element.

In another embodiment, updating the script includes adding a new action to the script based on a determination that the updated user interface includes an element associated with the action. When the updated user interface includes an element associated with the action of the script, the action has not yet been successfully completed and a new action is added to the script. In one embodiment, the newly added action is inserted into the script before the action.

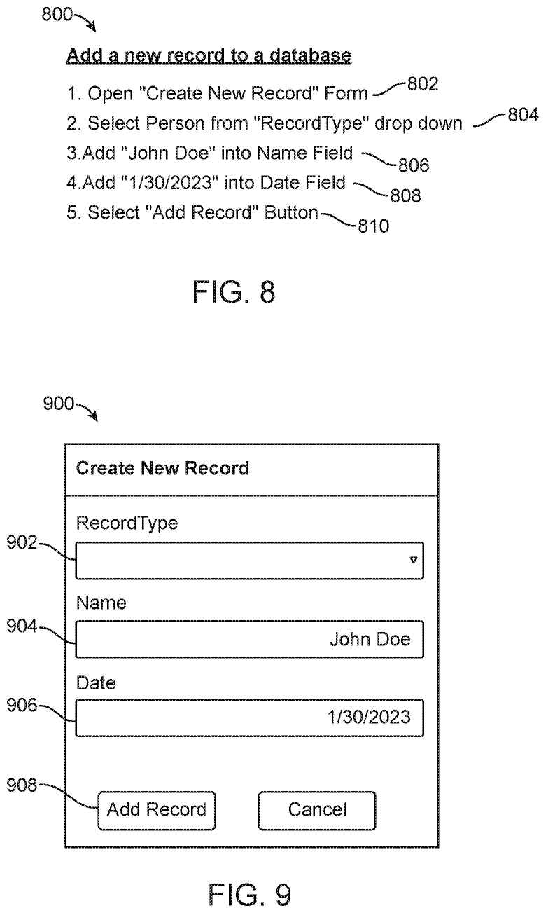

Referring now to FIG. 8, a testing script 800 for automated testing of the software under test in accordance with one or more embodiments is shown. As illustrated, the testing script 800 is a script for adding a new record to a database. The testing script 800 includes a series of actions that include a first action 802 “Open ‘Create New Record’ Form”, a second action 804 “Select Person from ‘Record Type’ drop down”, a third action 806 “Add ‘John Doe’ into Name Field”, a fourth action 808 “Add ‘Jan. 30, 2023’ into Date Field”, and a fifth action 810 “Select ‘Add Record’ button”. In one embodiment, the script 800 may also include other metadata that assists with the execution of the steps of the script. For example, the other metadata can include an expected location of a user interface element that corresponds to the step of the script.

Referring now to FIG. 9, an example of user interface 900 of a first version of the software under test in accordance with one or more embodiments is shown. The testing script 800 shown in FIG. 8, is a testing script that was created for the first version of the software under test that is depicted in FIG. 9. In one embodiment, after the first action 802 is successfully completed by the software under test and user interface 900 is displayed. The second action 804, third action 806, and fourth action 808 of the test script 800 are then executed by inserting/selecting the appropriate text into input fields 902, 904, and 906, respectively. Next, the fifth action 810 is performed by selecting the “Add Record” button 908 of the user interface 900. In one embodiment, once the “Add Record” button 908 of the user interface 900 is selected a record is created in a database and an event recording the creation of the record in the database is stored in the testing log 130, shown in FIG. 1.

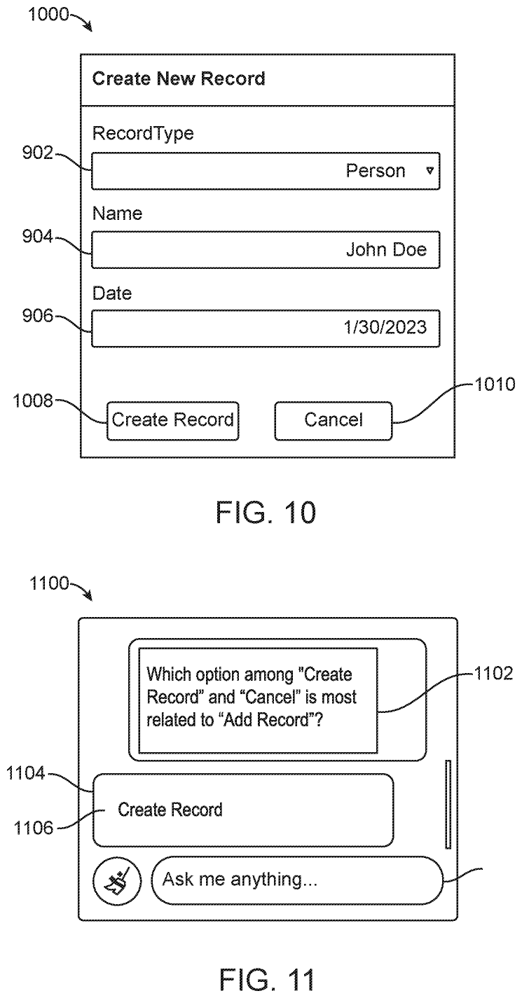

Referring now to FIG. 10 an example of user interface 1000 of a second version of the software under test in accordance with one or more embodiments is shown. As illustrated, user interface 1000 has been modified when compared to user interface 900, shown in FIG. 9, to replace the “Add Record” button 908 with a “Create Record” button 1008. As a result, when testing the software under test with the test script 900, the testing environment will not be able to perform the fifth action 810 “Select ‘Add Record’ button”. In one embodiment, based on a determination that the testing script 800 includes an action that cannot be completed, one or more elements 1008 and 1010 of the user interface 1000 of the software under test are identified.

Referring now to FIG. 11, an example of a query and response of a natural language processing system 1100 in accordance with one or more embodiments is shown. In one embodiment, the natural language processing system 1100 includes an input field 1101 that is used to submit a query 1102. In another embodiment, the query 1102 is input into the natural language processing system 1100 via an application programming interface (API) of the natural language processing system.

As illustrated, a query 1102 is provided to the natural language processing system 1100 that requests the natural language processing system 500 to identify one of the one or more elements “Create Record” button 1008 and “Cancel” button 1010 that is most closely related to the fifth action 810 “Select ‘Add Record’ button”. In response to the query 1102, the natural language processing system 1100 provides a response 1104 that includes an identified element 1106. In the illustrated example, the identified element 1106 is the “Create Record” element 1008.

Continuing with reference to FIG. 11, based on receiving the identified element 1106 from the natural language processing system, the testing of the software under test continues by selecting the “Create Record” element 1008 of the user interface 1000. Once the “Create Record” element 1008 of the user interface 1000 is selected, a record is created in a database and an event recording the creation of the record in the database is stored in the testing log 130, shown in FIG. 1. In one embodiment, the entry of the event in the testing log indicates that the fifth action 810 was successfully completed.

In one embodiment, the testing environment is configured to automatically update the testing script by creating and saving a new version of the testing script, each time an action is successfully performed using a response received from the natural language processing system. In one embodiment, telemetry data created by the software under test is used to determine if the action was successfully performed. For example, the telemetry data can indicate that an operation associated with the action was executed. In another embodiment, the determination that the action was successfully performed is based on an observed change in the user interface of the software under test. For example, upon successful completion of the action, an updated user interface may be displayed. In further embodiment, the completion of the action causes an event to be recorded in a testing log that can be used to verify that the action was completed.

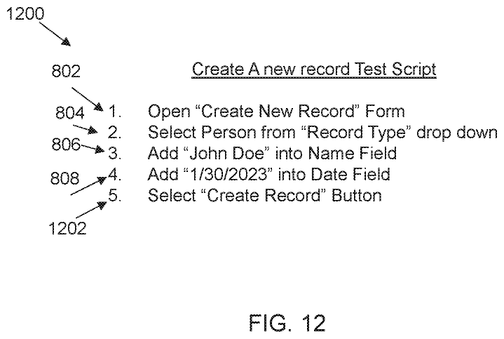

Referring now to FIG. 12 an updated testing script 1200 for automated testing of the software under test in accordance with one or more embodiments is shown. The updated testing script 1200 is an updated version of the testing script 800, shown in FIG. 8, that is created by the testing environment based on the detected changes to the user interface of the software under test and the input received from the natural language processing system. As illustrated, the updated testing script 1200 includes replacing the fifth action 810 “Select ‘Add Record’ button” with a new action 1202 “Select ‘Create Record’ button”.

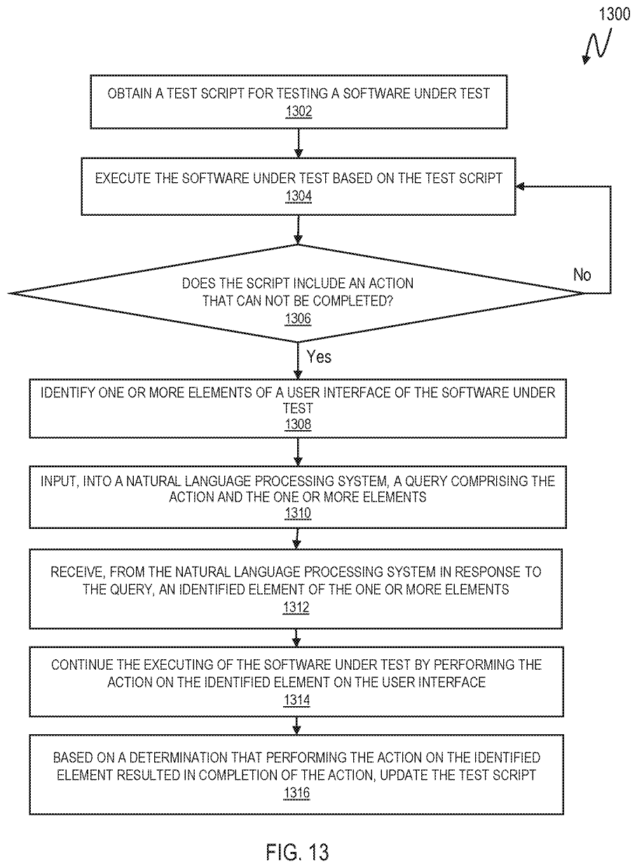

Referring now to FIG. 13, a flowchart of a method 1300 for automated software testing in accordance with one or more embodiments is shown. The method 1300 is described with reference to FIGS. 1 and 8-12 and may include additional steps not depicted in FIG. 13. Although depicted in a particular order, the blocks depicted in FIG. 13 can be, in some embodiments, rearranged, subdivided, and/or combined.

At block 1302, the method 1300 begins by obtaining a testing script for the software under test. In one embodiment, the test script is obtained from a user. In another embodiment, the test script is obtained by training a machine learning model with observational data of interactions of users with a prior version of the software under test.

At block 1304, the method 1300 includes executing the software under test. The software under test can include an operating system, application software, web-based software, and the like. In general, the software under test may be any type of software or application that has a user interface.

At decision block 1306, the method 1300 includes determining whether the testing script includes an action that cannot be completed. For example, the test script may include an action to select a specific user interface element, which is not present on the user interface. Based on a determination that the user interface of the software under test does not include an action that cannot be completed, the method 1300 returns to block 1304. Based on a determination that the user interface of the software under test does includes an action that cannot be completed, the execution of the software under test is paused and the method proceeds to block 1308.

At block 1308, the method 1300 includes identifying one or more elements of a user interface of the software under test. In one embodiment, the one or more elements of a user interface of the software under test represent the available options that are presented to a user via the user interface for possible execution. For example, the one or more elements may include textual input fields, buttons, drop down menus, and the like.

At block 1310, the method 1300 includes inputting into a natural language processing system the identified one or more elements of a user interface and the action as a query. In one embodiment, the query is input into the natural language processing system via an application programming interface (API) of the natural language processing system.

At block 1312, the method 1300 includes receiving, from the natural language processing system in response to the query, an identified element of the one or more elements. In one embodiment, the response from the query is received via the API of the natural language processing system.

At block 1314, the method 1300 includes continuing the executing of the software under test by performing the action on the identified element on the user interface. Once the identified element on the user interface has had the action performed against it, the software under test may complete the action. In one embodiment, the completion of the action causes an event to be recorded in a testing log that can be used to verify that the action was completed. In another embodiment, telemetry data created by the software under test is used to determine if the action was successfully performed. For example, the telemetry data can indicate that an operation associated with the action was executed.

At block 1316, the method 1300 includes updating the test script based on a determination that performing the action on the identified element resulted in the completion of the action. In one embodiment, the determination that performing the action on the identified element resulted in the completion of the action is based on the detection of an event associated with the action in a testing log. In one embodiment, updating the script includes updating the action to include the identified element based on a determination that the updated user interface includes an element associated with the consecutive action of the script.

In one embodiment, the method 1300 also includes transmitting an error notification to a user based on a determination that a testing log of the software under test does not include an event created in response to the completion of the action.

Although the embodiments shown above have illustrated embodiments where a single interaction between a testing environment and a natural language processing system was able to overcome an obstacle in executing a test script, the disclosure is not limited to such embodiments. In some embodiments, the testing environment is configured to iteratively interact with the natural language processing system to attempt to overcome an obstacle in executing a test script. For example, when the selection of an identified element by the natural language processing system does not result in the performance of the desired action, the testing environment can query the natural language processing system for a second user interface element that is related to the desired action. In another example, when the selection of an identified element by the natural language processing system does not result in the performance of the desired action, the testing environment can query the natural language processing system for a user interface element of an updated user interface that is displayed for an available user interface element that is related to the desire action.

In one embodiment, the amount of freedom that the testing environment is given to attempt to overcome an obstacle in executing a test script (i.e., the number of iterations between the testing environment and the natural language processing system) can be set by a user of the testing environment.

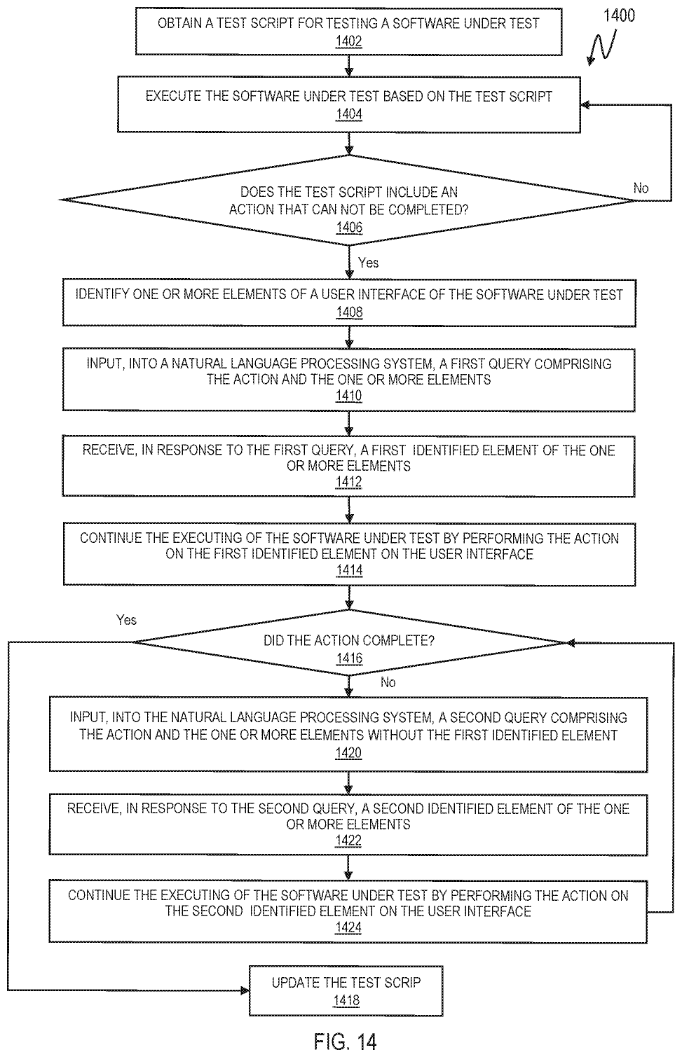

Referring now to FIG. 14, a flowchart of a method 1400 for automated software testing in accordance with one or more embodiments is shown. The method 1400 is described with reference to FIGS. 1 to 6 and 8 to 12 and may include additional steps not depicted in FIG. 14. Although depicted in a particular order, the blocks depicted in FIG. 14 can be, in some embodiments, rearranged, subdivided, and/or combined.

At block 1402, the method 1400 begins by obtaining a testing script for the software under test. In one embodiment, the test script is obtained from a user. In another embodiment, the test script is obtained by training a machine learning model with observational data of interactions of users with a prior version of the software under test.

At block 1404, the method 1400 includes executing the software under test. The software under test can include an operating system, application software, web-based software, and the like. In general, the software under test may be any type of software or application that has a user interface.

At decision block 1406, the method 1400 includes determining whether the testing script includes an action that cannot be completed. For example, the test script may include an action to select a specific user interface element, which is not present on the user interface. Based on a determination that the user interface of the software under test does not include an action that cannot be completed, the method 1400 returns to block 1404. Based on a determination that the testing script includes an action that cannot be completed, execution of the software under test is paused and the method 1400 proceeds to block 1408.

At block 1408, the method includes identifying one or more elements of a user interface of the software under test. In one embodiment, the one or more elements of a user interface of the software under test represent the available options that are presented to a user via the user interface for possible execution.

At block 1410, the method 1400 includes inputting into a natural language processing system the identified one or more elements of a user interface and the action as a first query. In one embodiment, the first query is input into the natural language processing system via an application programming interface (API) of the natural language processing system.

At block 1412, the method 1400 includes receiving, from the natural language processing system in response to the first query, a first identified element of the one or more elements. In one embodiment, the response from the first query is received via the API of the natural language processing system.

At block 1414, the method 1400 includes continuing the executing of the software under test by performing the action on the first identified element on the user interface. Once the first identified element on the user interface has the action performed against it, the software under test may complete the action. In one embodiment, the completion of the action causes an event to be recorded in a testing log that can be used to verify that the action was completed.

At decision block 1416, the method 1400 includes determining whether performing the action on the first identified element resulted in the action being completed. In one embodiment, the completion of the action causes an event to be recorded in a testing log that can be used to verify that the action was completed. In another embodiment, telemetry data created by the software under test is used to determine if the action was successfully performed. For example, the telemetry data can indicate that an operation associated with the action was executed.

Based on a determination that the first identified element resulted in the action being completed, the method proceeds to block 1418, and includes updating the test script. In one embodiment, updating the script includes updating the action to include the identified element based on a determination that the updated user interface includes an element associated with the consecutive action of the script.

Based on a determination that the first identified element did not result in the action being completed, execution of the software under test is paused and the method proceeds to block 1420. At block 1420, the method 1400 includes inputting, into the natural language processing system, a second query comprising the action and the one or more elements without the first identified element.

At block 1422, the method 1400 includes receiving, from the natural language processing system in response to the second query, a second identified element of the one or more elements. In one embodiment, the response from the second query is received via the API of the natural language processing system. In another embodiment, the response from the second query is obtained from the user interface of the natural language processing system.

At block 1424, the method 1400 includes continuing the executing of the software under test by performing the action on the second identified element on the user interface. After selection of the second identified element on the user interface, the method 1400 returns decision block 1416.

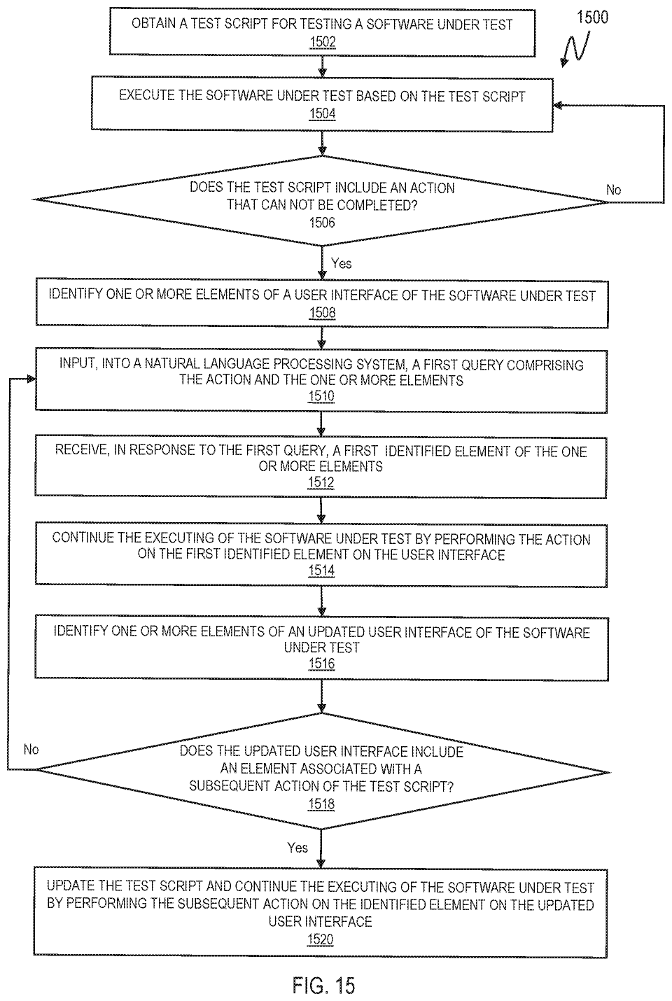

Referring now to FIG. 15, a flowchart of a method 1500 for automated software testing in accordance with one or more embodiments is shown. The method 1500 is described with reference to FIGS. 1 to 6 and 8 to 12 and may include additional steps not depicted in FIG. 15. Although depicted in a particular order, the blocks depicted in FIG. 15 can be, in some embodiments, rearranged, subdivided, and/or combined.

At block 1502, the method 1500 begins by obtaining a testing script for the software under test. In one embodiment, the test script is obtained from a user. In another embodiment, the test script is obtained by training a machine learning model with observational data of interactions of users with a prior version of the software under test.

At block 1504, the method 1500 includes executing the software under test. The software under test can include an operating system, application software, web-based software, and the like. In general, the software under test may be any type of software or application that has a user interface.

At decision block 1506, the method 1500 includes determining whether the testing script includes an action that cannot be completed. For example, the test script may include an action to select a specific user interface element, which is not present on the user interface. Based on a determination that the user interface of the software under test does not include an action that cannot be completed, the method 1500 returns to block 1504.

Based on a determination that the testing script includes an action that cannot be completed, the method 1500 proceeds to block 1508 and identifies one or more elements of a user interface of the software under test. In one embodiment, the one or more elements of a user interface of the software under test represent the available options that are presented to a user via the user interface for possible execution.

At block 1510, the method 1500 includes inputting into a natural language processing system the identified one or more elements of a user interface and the action as a first query. In one embodiment, the first query is input into the natural language processing system via an application programming interface (API) of the natural language processing system. In another embodiment, the first query is input into an input field of a user interface of the natural language processing system.

At block 1512, the method 1500 includes receiving, from the natural language processing system in response to the first query, a first identified element of the one or more elements. In one embodiment, the response from the first query is received via the API of the natural language processing system. In another embodiment, the response from the first query is obtained from the user interface of the natural language processing system.

At block 1514, the method 1500 includes continuing the executing of the software under test by performing the action on the first identified element on the user interface. Once the first identified element on the user interface has the action performed against it, the software under test may complete the action. In one embodiment, the completion of the action causes an event to be recorded in a testing log that can be used to verify that the action was completed.

At block 1516, the method 1500 includes identifying one or more elements of an updated user interface of the software under test. In embodiments, where performing the action on the identified element on the user interface does not cause an updated user interface of the software under test to be displayed, the one or more elements of the existing user interface of the software under test are identified.

At decision block 1518, the method 1500 includes determining whether the one or more elements of the updated user interface include an element associated with a subsequent action of the test script. As used herein, a subsequent action of a script is any action of the test script after the action. For example, in the test script 600 shown in FIG. 6, actions 204, 602, 206, and 208 are subsequent actions to action 202. Based on a determination that the one or more elements of the updated user interface do not include an element associated with a subsequent action of the test script, the method 1500 returns to block 1510 and queries the natural language processing system with the next action of the test script and the elements of the updated user interface. Based on a determination that the one or more elements of the updated user interface does include an element associated with a subsequent action of the test script, the method 1500 proceeds to block 1520.

At block 1520, the method 1500 includes updating the test script and continuing the executing of the software under test by performing the subsequent action on the identified element on the updated user interface. In one embodiment, if the elements of the updated user interface include elements associated with multiple subsequent actions of the test script, the earliest action in the test script is performed.

FIG. 16 illustrates aspects of an embodiment of a computer system 1600 that can perform various aspects of embodiments described herein. In some embodiments, the computer system(s) 1600 can implement and/or otherwise be incorporated within or in combination with any of the methods 700, 1300, 1400, and 1500 described previously herein. In some embodiments, a computer system 1600 can be configured to carry out the functionality of the testing environment 110. In some embodiments, a computer system 1600 can be configured to carry out the functionality of the natural language processing system 120.

The computer system 1600 includes at least one processing device 1602, which generally includes one or more processors or processing units for performing a variety of functions, such as, for example, completing any portion of the methods 700, 1300, 1400, and 1500 described previously herein. Components of the computer system 1600 also include a system memory 1604, and a bus 1606 that couples various system components including the system memory 1604 to the processing device 1602. The system memory 1604 may include a variety of computer system readable media. Such media can be any available media that is accessible by the processing device 1602, and includes both volatile and non-volatile media, and removable and non-removable media. For example, the system memory 1604 includes a non-volatile memory 1608 such as a hard drive, and may also include a volatile memory 1610, such as random access memory (RAM) and/or cache memory. The computer system 1600 can further include other removable/non-removable, volatile/non-volatile computer system storage media.

The system memory 1604 can include at least one program product having a set (e.g., at least one) of program modules that are configured to carry out functions of the embodiments described herein. For example, the system memory 1604 stores various program modules that generally carry out the functions and/or methodologies of embodiments described herein. A module or modules 1612, 1614 may be included to perform functions related to the methods 700, 1300, 1400, and 1500 as described previously herein. The computer system 1600 is not so limited, as other modules may be included depending on the desired functionality of the computer system 1600. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 1602 can also be configured to communicate with one or more external devices 1616 such as, for example, a keyboard, a pointing device, and/or any devices (e.g., a network card, a modem) that enable the processing device 1602 to communicate with one or more other computing devices. Communication with various devices can occur via Input/Output (I/O) interfaces 1618 and 1620.

The processing device 1602 may also communicate with one or more networks 1622 such as a local area network (LAN), a general wide area network (WAN), a bus network and/or a public network (e.g., the Internet) via a network adapter 1624. In some embodiments, the network adapter 1624 is or includes an optical network adaptor for communication over an optical network. It should be understood that although not shown, other hardware and/or software components may be used in conjunction with the computer system 1600. Examples include microcode, device drivers, redundant processing units, external disk drive arrays, RAID systems, and data archival storage systems.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted, or modified. All of these variations are considered a part of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, and “passing to” describe a communication path between two elements and does not imply a direct connection between the elements with no intervening elements/connections therebetween unless specified. A respective communication path can be a direct or indirect communication path.

For the sake of brevity, conventional techniques related to making and using aspects of the disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for automated testing of software, the method comprising:
obtaining a test script for testing the software;
executing the software based on the test script;
determining that the test script includes an action that cannot be completed;
identifying one or more elements of a user interface of the software;
inputting, into a natural language processing system, a query comprising the action and the one or more elements;
receiving, from the natural language processing system in response to the query, an identified element of the one or more elements;
continuing the executing of the software by performing the action on the identified element on the user interface;
determining that an updated user interface includes a user interface element associated with the action of the test script; and
updating the test script, wherein updating the test script includes adding a new action to the test script based on a determination that the updated user interface includes the element associated with the action.

2. The method of claim 1, further comprising determining that the updated user interface includes the user interface element associated with a consecutive action of the test script.

3. The method of claim 2, wherein updating the test script includes updating the test script to include the identified element based on a determination that the updated user interface includes the user interface element associated with the consecutive action of the test script.

4. The method of claim 1, wherein the natural language processing system includes a trained large language model.

5. The method of claim 1, wherein determining that the test script includes the action that cannot be completed includes determining that the action refers to a first user interface element that is not one of the one or more elements of the user interface of the software.

6. The method of claim 1, wherein the test script is obtained by training a machine learning model with observational data of interactions of users with a prior version of the software.

7. The method of claim 1, further comprising:
determining that the updated user interface does not include an element associated with at least one of the action and the consecutive action of the test script; and
transmitting an error notification.

8. A method for automated testing of software, the method comprising:
obtaining a test script for testing the software;
executing the software based on the test script;
determining that the test script includes an action that cannot be completed;
identifying one or more elements of a user interface of the software;
inputting, into a natural language processing system, a query comprising the action and the one or more elements;
receiving, from the natural language processing system in response to the query, an identified element of the one or more elements;
continuing the executing of the software by performing the action on the identified element on the user interface;
determining that performing the action on the identified element resulted in completion of the action; and
updating the test script.

9. The method of claim 8, wherein updating the test script includes updating the action to include the identified element.

10. The method of claim 8, wherein the natural language processing system includes a trained large language model.

11. The method of claim 8, wherein determining that the test script includes the action that cannot be completed includes determining that the action refers to a first user interface element that is not one of the one or more elements of the user interface of the software.

12. The method of claim 8, wherein the test script is obtained by training a machine learning model with observational data of interactions of users with a prior version of the software.

13. The method of claim 8, wherein the determining that performing the action on the identified element resulted in completion of the action is based on detection of an event associated with the action in a testing log.

14. A system having a memory, computer readable instructions, and a processing system for executing the computer readable instructions, the computer readable instructions controlling the processing system to perform operations comprising:
executing software based on a test script; and
determining that the test script includes an action that cannot be completed;
identifying one or more elements of a user interface of the software;
inputting, into a natural language processing system, a first query comprising the action and the one or more elements;
receiving, from the natural language processing system in response to the first query, a first identified element of the one or more elements;
continuing the executing of the software by performing the action on the first identified element on the user interface;
determining that performing the action on the first identified element resulted in completion of the action; and
updating the test script.

15. The system of claim 14, wherein the operations further comprise:
determining that performing the action on the first identified element did not result in completion of the action;
inputting, into the natural language processing system, a second query comprising the action and the one or more elements without the first identified element;
receiving, from the natural language processing system in response to the second query, a second identified element of the one or more elements;
continuing the executing of the software by performing the action on the second identified element on the user interface;
determining that performing the action on the second identified element resulted in completion of the action; and
updating the test script.

16. The system of claim 15, wherein the operations further comprise:
determining that performing the action on the second identified element did not result in completion of the action; and
transmitting an error notification to a user.

17. The system of claim 14, wherein the operations further comprise:
determining that performing the action on the first identified element did not result in completion of the action;
identifying one or more user interface elements of an updated user interface of the software;
inputting, into the natural language processing system, a second query comprising the action and the one or more user interface elements from the updated user interface;
receiving, from the natural language processing system in response to the second query, a second identified element;
continuing the executing of the software by performing the action on the second identified element on the updated user interface;
determining that performing the action on the second identified element resulted in completion of the action; and
updating the test script.

18. The system of claim 17, wherein the operations further comprise:
determining that performing the action on the second identified element did not result in completion of the action; and
transmitting an error notification to a user.

19. The system of claim 14, wherein the test script is obtained by training a machine learning model with observational data of interactions of users with a prior version of the software.

20. The system of claim 14, wherein the natural language processing system includes a trained large language model.
